(19) United States
(12) Patent Application Publication
(10) Pub. No.: US 2026/0167251 A1
(43) Pub. Date: Jun. 18, 2026

(54) FOLDABLE STEERING WHEEL

(71) Applicant: KOMOS CO., LTD., Hwaseong-si Gyeonggi-do (KR)

(72) Inventors: Hyeon Muk KIM, Seoul (KR); Dong Min KIM, Anyang-si Gyeonggi-do (KR); In Chul YOO, Hwaseong-si Gyeonggi-do (KR); Hyeoung Seok SONG, Suwon-si Gyeonggi-do (KR)

(73) Assignee: KOMOS CO., LTD., Hwaseong-si Gyeonggi-do (KR)

(21) Appl. No.: 19/421,319

(22) Filed: Dec. 16, 2025

(30) Foreign Application Priority Data
Dec. 17, 2024 (KR) 10-2024-0189027

(51) Int. Cl. B62D 1/06; B62D 1/10

(52) U.S. Cl. CPC B62D 1/06; B62D 1/10

(57) ABSTRACT

Provided is a foldable steering wheel. The foldable steering wheel includes a hub, a rim moving relative to the hub, and an actuator unit moving the rim with respect to the hub, the actuator unit includes a guide block provided in the hub and guiding a motion of the rim, and a first actuator installed on the guide block and linearly moving the rim forward and backward, and the rim performs linear motion by the first actuator between a first position in an unfolded state for a driver to grip the rim and a second position in a folded state.

### CROSS-REFERENCE TO RELATED APPLICATION

This application claims priority to Korean Patent Application No. 10-2024-0189027 filed on Dec. 17, 2024, the entire contents of which are herein incorporated by reference.

### BACKGROUND

### 1. Field

The disclosure relates to a foldable steering wheel. More particularly, the disclosure relates to a foldable steering wheel capable of securing driver's seat space by folding the steering wheel.

2. Description of the Related Art

General steering wheels have rims with large diameters disposed in driver's seat space for drivers'operation convenience. Drivers'postures in driver's seats are limited due to the sizes and positions of rims. Therefore, there is a problem that drivers are unable to take sufficient rest in relaxed postures in the driver's seats.

In addition, due to the fixed shapes and fixed positions of the rims, drivers'actions in the driver's seats are restricted, which causes a problem of narrowing the range of drivers'movements when driving autonomous vehicles.

### SUMMARY

Provided is a foldable steering wheel with a rim that folds or unfolds.

Provided also is a foldable steering wheel that automatically folds or unfolds depending on whether a vehicle is in an autonomous driving state.

Provided is a foldable steering wheel capable of securing driver's seat space by folding a rim through the linear motion and rotational motion of the rim.

Provided is a foldable steering wheel capable of firmly locking a rim in a folding position and unfolding position of the rim.

The solutions of the disclosure are not limited to the above-mentioned contents, and other technical problems not mentioned will be clearly understood by one of ordinary skill in the art from the following description.

According to an embodiment of the disclosure, a foldable steering wheel includes a hub, a rim moving relative to the hub, and an actuator unit moving the rim with respect to the hub, the actuator unit includes a guide block provided in the hub and guiding the motion of the rim, and a first actuator installed on the guide block and linearly moving the rim forward and backward, and the rim performs linear motion by the first actuator between a first position in an unfolded state for a driver to grip the rim and a second position in a folded state.

The first actuator may include a first rotation motor, a screw in an elongated shape provided on the guide block and rotated by the first rotation motor, a moving block coupled to the screw and performing linear motion forward and backward according to the rotation of the screw, and a rotation link rotatably connected to the moving block and to which the rim is coupled, and the rim may perform linear motion between the first position and the second position according to the motion of the moving block.

Guide grooves of different lengths may be provided in an upper portion and a lower portion of the guide block to rotate the rim at a predetermined angle at the second position, and insertion pins provided at both ends of the rotation link may be respectively inserted into the guide grooves and may move along the guide grooves.

The length of the guide groove in the lower portion of the guide block may be longer than the length of the guide groove in the upper portion of the guide block, and the rotation link may be rotated at the predetermined angle according to a length difference between the guide grooves in the upper portion and the lower portion at the second position so that the rim may rotate.

The foldable steering wheel may further include a locking unit using a rotating method to fix the rim to the guide block at the first position and the second position.

The locking unit may include a second rotation motor provided in the moving block, an output gear provided on an output shaft of the second rotation motor, and a plurality of jaws performing linear motion forward and backward according to the rotation of the output gear, locking holes into which the plurality of jaws are inserted may be provided in the guide block, and the motion of the rim may be blocked as the plurality of jaws are inserted into the locking holes.

A planetary reducer may be provided on the output shaft of the second rotation motor, the output gear may be a sun gear of the planetary reducer, and the plurality of jaws may be engaged with a link gear fixed to a ring gear of the planetary reducer.

The first rotation motor may be a brushless direct current (BLDC) motor, and the second rotation motor may be a step motor.

### BRIEF DESCRIPTION OF THE DRAWINGS

FIGS. 1A and 1B are perspective views respectively illustrating an unfolded state and a folded state of a foldable steering wheel according to an embodiment of the disclosure;

FIGS. 2A and 2B are side views respectively illustrating an unfolded state and a folded state of the foldable steering wheel of FIGS. 1A and 1B;

FIGS. 3A and 3B are diagrams illustrating main portions of the foldable steering wheel of FIGS. 1A and 1B;

FIG. 4 is a perspective view illustrating an actuator unit of a foldable steering wheel according to an embodiment of the disclosure;

FIG. 5 is an exploded perspective view illustrating the main configuration of a first actuator of a foldable steering wheel according to an embodiment of the disclosure;

FIG. 6 is an exploded perspective view illustrating the main configuration of a guide block of a foldable steering wheel according to an embodiment of the disclosure;

FIG. 7 is an exploded perspective view illustrating the main configuration of a locking unit of a foldable steering wheel according to an embodiment of the disclosure;

FIG. 8 is a diagram for explaining the main operations of a locking unit of a foldable steering wheel according to an embodiment of the disclosure;

FIGS. 9A and 9B are diagrams for explaining the main operations of a locking unit of a foldable steering wheel according to an embodiment of the disclosure;

FIG. 10 is a diagram for explaining the operation of a locking unit in unfolding and folding positions of a foldable steering wheel according to an embodiment of the disclosure;

FIGS. 11A and 11B are diagrams illustrating the configurations of an actuator unit before a lock state in a folding position of a foldable steering wheel according to an embodiment of the disclosure;

FIGS. 12A and 12B are diagrams illustrating the configurations of an actuator unit in a lock state from a folding position of a foldable steering wheel according to an embodiment of the disclosure; and

FIGS. 13A to 13D are diagrams sequentially illustrating operations of a foldable steering wheel according to an embodiment of the disclosure from an unfolding position to a folding position.

### DETAILED DESCRIPTION

The disclosure will now be described more fully with reference to the accompanying drawings, in which embodiments of the disclosure are shown. These embodiments are provided so that the disclosure will be thorough and complete, and will fully convey the concept of the disclosure to those of skill in the art. The disclosure may, however, be embodied in many different forms and should not be construed as being limited to the embodiments set forth herein. For clarity, portions that are not relevant to the description of the present disclosure are omitted.

The terms used in the present specification are merely used to describe particular embodiments of the disclosure, and are not intended to limit the disclosure. An expression used in the singular encompasses the expression of the plural, unless it has a clearly different meaning in the context.

In the present specification, it is to be understood that the terms such as “including”, “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In addition, the components shown in the embodiments of the disclosure are shown independently to represent different characteristic functions, and do not mean that each component includes separate hardware or one software unit. That is, each component is described by listing each component for convenience of description, and at least two of the components may be combined to form one component, or one component may be divided into a plurality of components to perform a function. The integrated and separated embodiments of each of these components are also included within the scope of the disclosure without departing from the spirit of the disclosure.

In addition, embodiments below are provided so that the present disclosure will be thorough and complete, and will fully convey the concept of the disclosure to those skilled in the art. In the drawings, sizes and thicknesses of components may be exaggerated for clarity.

Hereinafter, the disclosure will be described in detail with reference to the attached drawings.

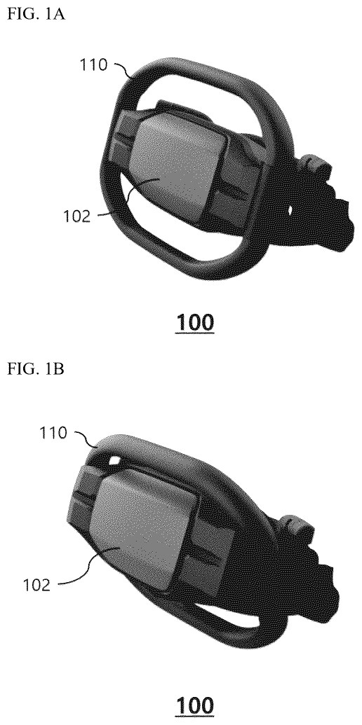

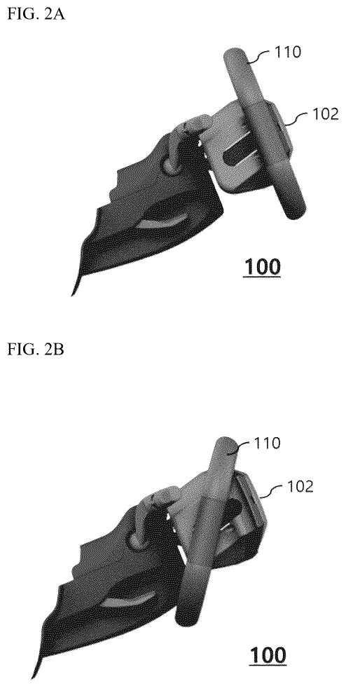

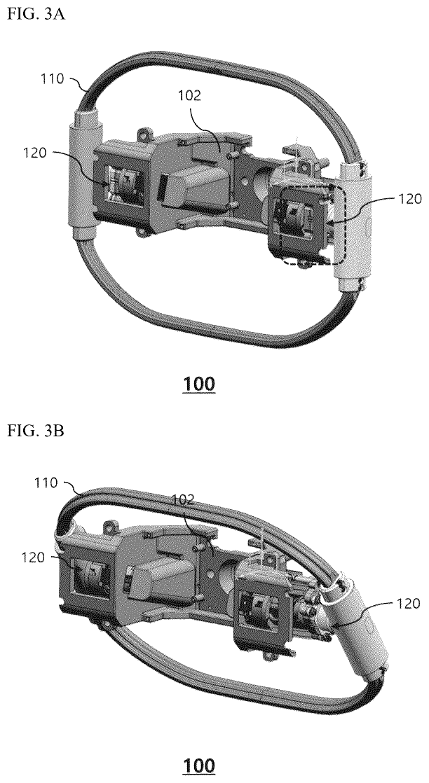

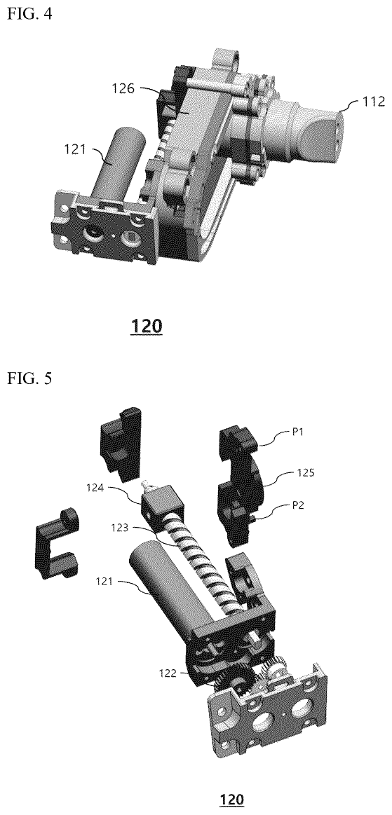

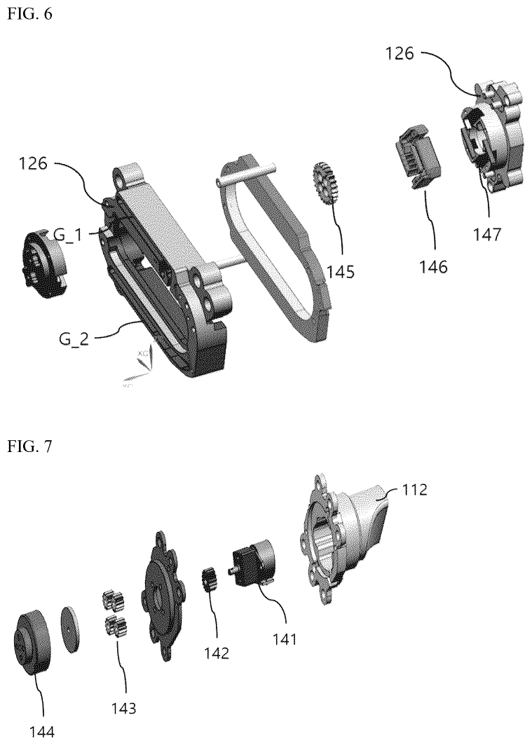

FIGS. 1A and 1B are perspective views respectively illustrating an unfolded state and a folded state of a foldable steering wheel 100 according to an embodiment of the disclosure. FIGS. 2A and 2B are side views respectively illustrating the unfolded state and a folded state of the foldable steering wheel 100 of FIGS. 1A and 1B. FIGS. 3A and 3B are diagrams illustrating main portions of the foldable steering wheel 100 of FIGS. 1A and 1B. FIG. 4 is a perspective view illustrating an actuator unit 120 of the foldable steering wheel 100 according to an embodiment of the disclosure. FIG. 5 is an exploded perspective view illustrating the main configuration of a first actuator of the foldable steering wheel 100 according to an embodiment of the disclosure. FIG. 6 is an exploded perspective view illustrating the main configuration of a guide block 126 of the foldable steering wheel 100 according to an embodiment of the disclosure.

Referring to FIGS. 1A to 6, the foldable steering wheel 100 according to an embodiment of the disclosure is capable of conversion between a folding position and an unfolding position, thereby improving the convenience of a driver and the utilization of vehicle space. The foldable steering wheel 100 may implement a foldable function by moving a rim 110 forward and backward with respect to a hub 102 and rotating the rim 110 at a predetermined angle at a specific position, thereby increasing the utilization of driver's seat space. The foldable steering wheel 100 may include the hub 102, the rim 110, and the actuator unit 120.

The hub 102 is a central part of the foldable steering wheel 100, and may be connected to a steering column of a vehicle, accommodate an airbag therein, and accommodate various components.

The rim 110 is a part gripped by the driver, and in the present embodiment, an upper rim and a lower rim may be provided integrally or provided separately and combined to move relative to the hub 102 integrally.

The actuator unit 120 may move the rim 110 relative to the hub 102, and may move the rim 110 forward and backward between a first position in a state where the rim 110 unfolds for the driver to grip the rim 110 and a second position in a state where the rim 110 folds. In addition, the actuator unit 120 may rotate the rim 110 at a predetermined angle with respect to the hub 102 at the second position. The actuator unit 120 may include the guide block 126 and the first actuator. The guide block 126 may be provided at the hub 102 to stably guide the motion of the rim 110. In the present embodiment, it will be described as an example that the actuator unit 120 is provided at each end of the hub 102. However, according to an embodiment, the actuator unit 120 may be provided only on any one of the left and right sides of the hub 102. The first actuator may be installed on the guide block 126 to linearly move the rim 110 forward and backward. In addition, the first actuator may rotate the rim 110 at a predetermined angle by the cooperation between the guide block 126 and the first actuator at the second position. That is, by the cooperation between the first actuator and the guide block 126, the rim 110 is capable of moving in the front and back direction toward the driver with respect to the hub 102 and at the same time may be folded (laid down) at a specific position.

The first actuator may include a first rotation motor 121, a screw 123, a moving block 124, and a rotation link 125. The first rotation motor 121 is for rotating the elongated screw 123, and may rotate the screw 123 through a reduction gear 122 to increase torque. For example, the first rotation motor 121 may be a brushless direct current (BLDC) motor with low noise. In the present embodiment, it has been described as an example that the screw 123 is a lead screw with a thread formed on its outer circumference in an elongated shape but the disclosure is not limited thereto, and a ball screw may be used. The moving block 124 may be coupled to the screw 123 and may perform linear motion forward and backward according to the rotation of the screw 123. Accordingly, the rim 110 connected to the moving block 124 through a rim connection unit 112 may perform linear motion according to the movement of the moving block 124. The rotation link 125 may be connected to the moving block 124 such that its center may be rotatable. Insertion pins P1 and P2 having a protruding shape may be provided at both ends of the rotation link 125, and may move by being respectively inserted into and guided by guide grooves G_1 and G_2 respectively provided at an upper portion and a lower portion of the guide block 126.

On the other hand, the guide grooves G_1 and G_2 for rotating the rim 110, which performs linear motion, at a determined angle at a predetermined position, for example, the folding position, which is the second position, may be provided in the guide block 126. As shown, the guide grooves G_1 and G_2 may be provided in an elongated shape respectively at the upper portion and the lower portion of the guide block 126, and the upper guide groove G_1 and the lower guide groove G_2 may have different lengths. In the present embodiment, the length of the lower guide groove G_2 of the guide block 126 is longer than the length of the upper guide groove G_1, and due to a difference in the lengths of the upper guide groove G_1 and the lower guide groove G_2 at the second position, the rotation link 125 is rotated at a predetermined angle, and thus, the rim 110 connected to the rotation link 125 may rotate.

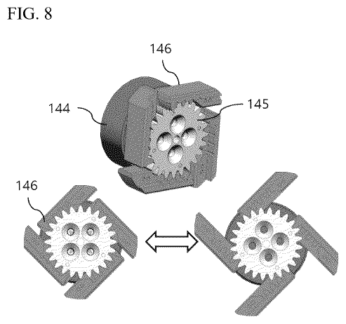

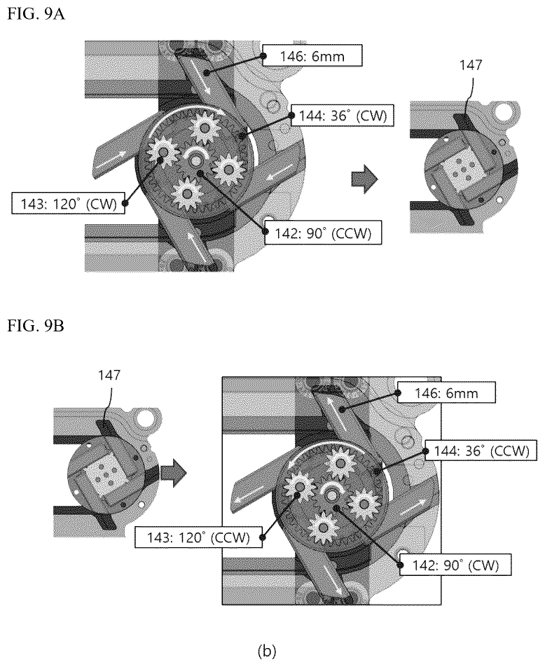

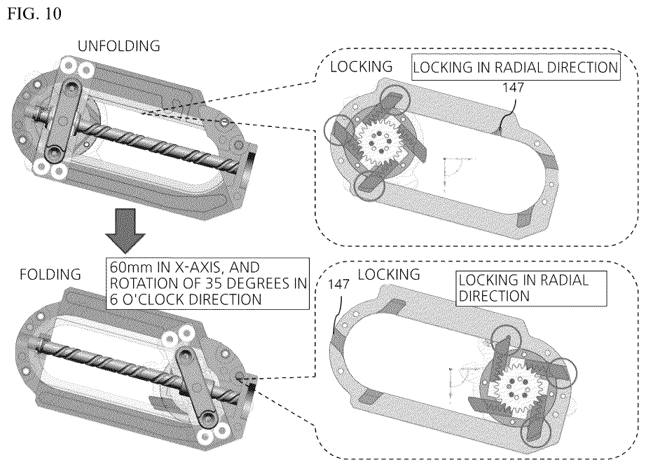

FIG. 7 is an exploded perspective view illustrating the main configuration of a locking unit of the foldable steering wheel 100 according to an embodiment of the disclosure, FIG. 8 is a diagram for explaining the main operations of the locking unit of the foldable steering wheel 100 according to an embodiment of the disclosure, and FIGS. 9A and 9B are diagrams for explaining the main operations of the locking unit of the foldable steering wheel 100 according to an embodiment of the disclosure. FIG. 10 is a diagram for explaining the operation of the locking unit in unfolding and folding positions of the foldable steering wheel 100 according to an embodiment of the disclosure.

Referring to FIGS. 7 to 10, the foldable steering wheel 100 according to an embodiment of the disclosure may further include the locking unit. The locking unit is for fixing the rim 110 to the guide block 126 at folding and unfolding positions of the rim 110. this embodiment, the locking unit may use a rotating method. Specifically, the locking unit may include a second rotation motor 141, an output gear 142, and one or more jaws 146. The second rotation motor 141 may be provided on the moving block 124 to perform linear motion together with the moving block 124. In an embodiment, the second rotation motor 141 may be a step motor for controlling an accurate rotation angle. The output gear 142 may be provided on an output shaft of the second rotation motor 141 and rotate according to the rotation of the output shaft. The plurality of jaws 146 perform linear motion forward and backward according to the rotation of the output gear 142, and may be inserted into respective corresponding locking holes 147 provided in the guide block 126. That is, a gear portion in a rod shape that may be engaged with the output gear 142 may be provided at one end of each jaw 146, the gear portion of the jaw 146 may be engaged to perform linear motion according to the rotation of the output gear 142, and the jaw 146 may move forward and backward linearly with respect to the locking hole 147 according to the rotation direction of the output gear 142. When the jaw 146 is inserted into the locking hole 147, the motion of the second rotation motor 141 and the moving block 124 may be fixed, and accordingly, the motion of the rim 110 may be blocked, and the position thereof may be fixed. Accordingly, it is possible to prevent the rim 110 of the steering wheel 100 from moving even when an external force by a driver or other external force is applied at a first position and a second position.

In an embodiment, a planetary reducer 143 may be provided on the output shaft of the second rotation motor 141. The output gear 142 may act as a sun gear of the planetary reducer 143, and the jaw 146 may be engaged with a link gear 145 fixed to a ring gear 144 of the planetary reducer 143. In the present embodiment, the four jaws 146 may be provided to be perpendicular to each other at 90 degree intervals, and may be engaged with the link gear 145 at 90 degree intervals. On the other hand, the three locking holes 147 may be provided in the guide block 126 with respect to the outer circumference of the guide block 126 in which the screw 123 is not installed at folding and unfolding positions.

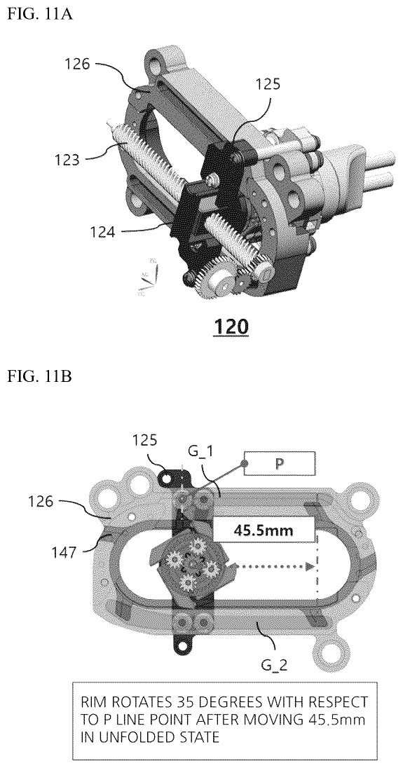

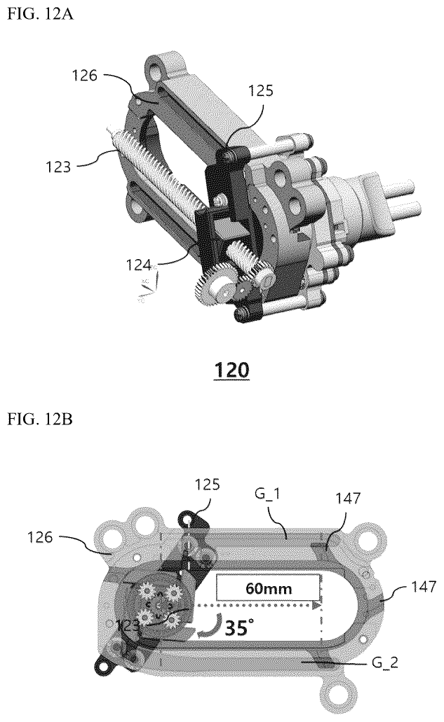

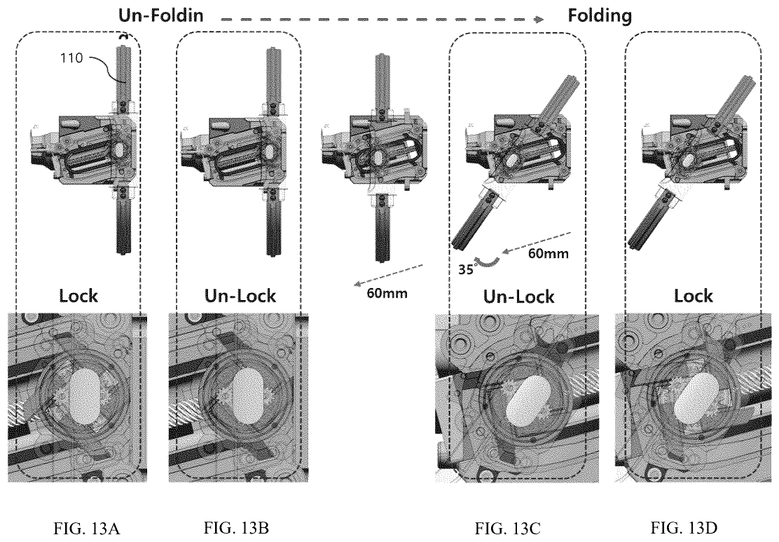

FIGS. 11A and 11B are diagrams illustrating the configurations of an actuator unit before a lock state in a folding position of the foldable steering wheel 100 according to an embodiment of the disclosure. FIGS. 12A and 12B are diagrams illustrating the configurations of the actuator unit in a lock state from a folding position of the foldable steering wheel 100 according to an embodiment of the disclosure. FIGS. 13A to 13D are diagrams sequentially illustrating operations of the foldable steering wheel 100 according to an embodiment of the disclosure from an unfolding position to a folding position.

Hereinafter, the operation of the foldable steering wheel 100 according to an embodiment of the disclosure will be described with reference to FIGS. 9A to 13D. First, the locked rim 110 is unlocked at a first position (FIG. 13A), which is the position of a driver's operation state (unfolded steering wheel). Specifically, the second rotation motor 141 of a locking unit operates to separate the plurality of jaws 146 inserted into the locking holes 147 provided in the guide block 126 at the first position from the locking holes 147 (FIG. 13B). Thereafter, the first rotation motor 121 of a first actuator operates to rotate the screw 123. As the screw 123 rotates, the moving block 124 performs linear motion in a direction away from a driver according to the guide of the guide block 126, and the rim 110 connected to the moving block 124 performs linear motion together to reach the vicinity of a second position (FIG. 13C). Here, due to a length difference between the upper guide groove G_1 and the lower guide groove G_2 of the guide block 126, the rotation link 125 rotates at a predetermined angle with respect to the moving block 124, and accordingly, the rim 110 rotates. In an embodiment, the rim 110 may rotate 35 degrees clockwise. When the moving block 124 reaches a determined position, a limit switch (not shown) operates, and accordingly, the second rotation motor 141 of the locking unit operates, and the plurality of planetary gears 143 rotate according to the rotation of the sun gear 142 provided on the output shaft of the second rotation motor 141 which is a step motor, the ring gear 144 rotates according to the rotation of the planetary gear 143, and as the link gear 145 fixed to the ring gear 144 rotates, the plurality of jaws 146 engaged with the link gear 145 perform linear motion in a radial direction away from the rotation shaft of the second rotation motor 141. The plurality of jaws 146 may be respectively inserted into the plurality of locking holes 147 provided in the guide block 126 to block the motion of the rim 110 and firmly fix the rim 110 (FIG. 13D). The rim 110 rotates and is fixed at the second position, and thus, the driver's space expands, and the driver may efficiently use the expanded internal space.

Hereinafter, an operation from a folded state to an unfolded state will be described. First, the locking unit unlocks the locked rim 110 at the second position, which is a position where the rim 110 of the foldable steering wheel 100 folds (laid down). Specifically, as an output gear, i.e., the sun gear 142, provided on the output shaft of the second rotation motor 141 that is the step motor of the locking unit rotates, the plurality of planetary gears 143 rotate, the ring gear 144 rotates according to the rotation of the planetary gear 143, and as the link gear 145 fixed to the ring gear 144 rotates, the plurality of jaws 146 having ends engaged with the link gear 145 perform linear motion in a direction toward the rotation shaft of the second rotation motor 141. In this regard, the respective jaws 146 may be separated from the respective locking holes 147 of the guide block 126. Accordingly, the locked rim 110 may be unlocked. Thereafter, the first rotation motor 121 operates to rotate the screw 123. According to the rotation of the screw 123, the moving block 124 performs linear motion in a direction of the first position, which is a direction close to the driver according to the guide of the guide block 126. In this case, the rim 110 inclined by a length difference between the upper guide groove G_1 and the lower guide groove G_2 of the guide block 126 may be rotated to a vertical position in the original direction by its own weight. Subsequently, the rim 110 connected to the moving block 124 performs linear motion with the moving block 124 to move to the first position. When the moving block 124 reaches the first position, a limit switch (not shown) operates, and accordingly, the plurality of planetary gears 143 rotate according to the rotation of the output gear 142 provided on the output shaft of the second rotation motor 141 which is a step motor, the ring gear 144 rotates according to the rotation of the planetary gear 143, and as the link gear 145 fixed to the ring gear 144 rotates, the plurality of jaws 146 having ends engaged with the link gear 145 perform linear motion in a radial direction away from the rotation shaft of the second rotation motor 141. The plurality of jaws 146 may be respectively inserted into the plurality of locking holes 147 provided in the guide block 126 to firmly fix the rim 110. Accordingly, the driver is in a state capable of performing steering by gripping the rim 110.

The foldable steering wheel according to the above-described embodiment may have the rim that folds or unfolds. In addition, the steering wheel may automatically fold or unfold depending on whether a vehicle is in an autonomous driving state, and fold the rim through the linear motion and rotational motion of the rim, thereby securing the driver's seat space. In addition, the foldable steering wheel may firmly lock the rim at the folding and unfolding positions of the rim.

In the foldable steering wheel according to an embodiment of the disclosure, a rim may fold or unfold.

In addition, the foldable steering wheel may automatically fold or unfold depending on whether a vehicle is in an autonomous driving state.

In addition, the foldable steering wheel may secure the driver's seat space by folding the rim through the linear motion and rotational motion of the rim.

In addition, the foldable steering wheel may firmly lock the rim at the folding and unfolding positions of the rim.

The effects of the disclosure are not limited to the above-mentioned effects, and other effects not mentioned will be clearly understood by one of ordinary skill in the art from the description provided above.

Although the disclosure has been described with reference to the embodiment shown in the drawings, this is merely exemplary and will be understood by one of ordinary skill in the art that various modifications and equivalent other embodiments are possible. Therefore, the true technical protection scope of the disclosure will be defined by the technical sprit of the appended claims.

What is claimed is:

1. A foldable steering wheel comprising:
a hub;
a rim moving relative to the hub; and
an actuator unit moving the rim with respect to the hub,
wherein the actuator unit includes:
a guide block provided in the hub and guiding a motion of the rim; and
a first actuator installed on the guide block and linearly moving the rim forward and backward, and
the rim performs linear motion by the first actuator between a first position in an unfolded state for a driver to grip the rim and a second position in a folded state.

2. The foldable steering wheel of claim 1, wherein the first actuator includes:
a first rotation motor;
a screw in an elongated shape provided on the guide block and rotated by the first rotation motor;
a moving block coupled to the screw and performing linear motion forward and backward according to a rotation of the screw; and
a rotation link rotatably connected to the moving block and to which the rim is coupled, and
the rim performs linear motion between the first position and the second position according to a motion of the moving block.

3. The foldable steering wheel of claim 2, wherein guide grooves of different lengths are provided in an upper portion and a lower portion of the guide block to rotate the rim at a predetermined angle at the second position, and insertion pins provided at both ends of the rotation link are respectively inserted into the guide grooves and move along the guide grooves.

4. The foldable steering wheel of claim 3, wherein a length of the guide groove in the lower portion of the guide block is longer than a length of the guide groove in the upper portion of the guide block, and the rotation link is rotated at the predetermined angle according to a length difference between the guide grooves in the upper portion and the lower portion at the second position so that the rim rotates.

5. The foldable steering wheel of claim 2, further comprising a locking unit using a rotating method to fix the rim to the guide block at the first position and the second position.

6. The foldable steering wheel of claim 5, wherein the locking unit includes:
a second rotation motor provided in the moving block;
an output gear provided on an output shaft of the second rotation motor; and
a plurality of jaws performing linear motion forward and backward according to a rotation of the output gear,
wherein locking holes into which the plurality of jaws are inserted are provided in the guide block, and
a motion of the rim is blocked as the plurality of jaws are inserted into the locking holes.

7. The foldable steering wheel of claim 6, wherein a planetary reducer is provided on the output shaft of the second rotation motor, the output gear is a sun gear of the planetary reducer, and the plurality of jaws are engaged with a link gear fixed to a ring gear of the planetary reducer.

8. The foldable steering wheel of claim 6, wherein the first rotation motor is a brushless direct current (BLDC) motor, and the second rotation motor is a step motor.
